(19) United States
(12) Patent Application Publication
(10) Pub. No.: US 2024/0177552 A1
(43) Pub. Date: May 30, 2024

(54) KNOB HOLDING STRUCTURE AND SMART LOCK

(71) Applicant: Fujitsu Component Limited, Tokyo (JP)

(72) Inventors: Yuji Yada, Tokyo (JP); Tetsuhiro Ishikawa, Tokyo (JP)

(21) Appl. No.: 18/487,927

(22) Filed: Oct. 16, 2023

(30) Foreign Application Priority Data
Nov. 30, 2022 (JP) 2022-191806

(51) Int. Cl. G07C 9/00

(52) U.S. Cl. CPC G07C 9/00944

(57) ABSTRACT

A knob holding structure according to one aspect of the present disclosure has a holder, a pair of pinching members configured to hold a knob and arranged opposed to each other in the holder, and an elastic member configured to support the pair of pinching members so that each pinching member can be displaced relative to an inner surface of the holder, and to bias the pinching members in a direction so as to approach each other.

### CROSS-REFERENCE TO RELATED APPLICATIONS

This application is based upon and claims the benefit of priority of the prior Japanese Patent Application No. 2022-191806 filed on Nov. 30, 2022, the entire content of which is incorporated herein by reference.

### BACKGROUND

A certain aspect of the embodiments relates to a knob holding structure and a smart lock.

A conventional smart lock is a device which unlocks and locks a door by password input, fingerprint authentication, or remote control from an electronic device such as a smartphone, and has a holding means for holding a knob to unlock and lock the door such as a thumb-turn, and a drive means for rotating the holding means.

A mechanism has been proposed, wherein an error in a mounting position of a smart lock with respect to a door can be absorbed by the mechanism. For example, a smart lock device is well known which has a configuration in which a soft rubber sleeve is inserted inside a cover configured to fix a thumb-turn.

Also, there is known a technique for correcting a deviation or eccentricity between a door lock and a door installation mechanism, by using rubber, sponge, robot fingers, etc. as a coupling for rotating the thumb-turn.

### RELATED ART

[Patent Literature 1] JP 2020-204164 A
[Patent Literature 2] JP 2018-028259 A

When attaching a smart lock to a door, etc., in order to securely fix a knob holding means to a knob with their rotation centers aligned, the two are positioned and then fixed using screws, etc. However, such positioning and fixing operations are complicated and troublesome work for an operator.

Although some techniques for absorbing the positioning error have been proposed as described above, there is a demand for a knob holding structure and a smart lock having a simpler configuration and a structure which can improve the efficiency of operations related to positioning and fixing.

### SUMMARY

A knob holding structure according to one aspect of the present disclosure comprises: a holder; a pair of pinching members configured to hold a knob and arranged opposed to each other in the holder; and an elastic member configured to support the pair of pinching members so that each pinching member can be displaced relative to an inner surface of the holder, and to bias the pinching members in a direction so as to approach each other.

A smart lock according to another aspect of the present disclosure comprises: the above knob holding structure and a drive mechanism configured to rotationally drive the holder.

According to the present disclosure, when attaching the smart lock to a door, etc., the pair of pinching members can be automatically elastically displaced corresponding to the position and/or the shape of the knob. Therefore, the knob can be appropriately held while greatly reducing the amount of work required of the operator.

### BRIEF DESCRIPTION OF DRAWINGS

FIG. 1 is a perspective view of a smart lock according to an embodiment;

FIG. 2 is a perspective view of the smart lock of FIG. 1 viewed from another angle;

FIG. 3 is a perspective view showing an object to which the smart lock is attached;

FIG. 4 is a perspective view of a configuration example of a knob holding structure;

FIG. 5 is a perspective view of the knob holding structure of FIG. 4 viewed from another angle;

FIG. 6 is a cross-sectional view along an A-A line of FIG. 5; and

FIG. 7 is a perspective view of a drive mechanism of the knob holding structure.

### DESCRIPTION OF EMBODIMENTS

Hereinafter, a description will be given of the embodiment of the present invention with reference to the drawings.

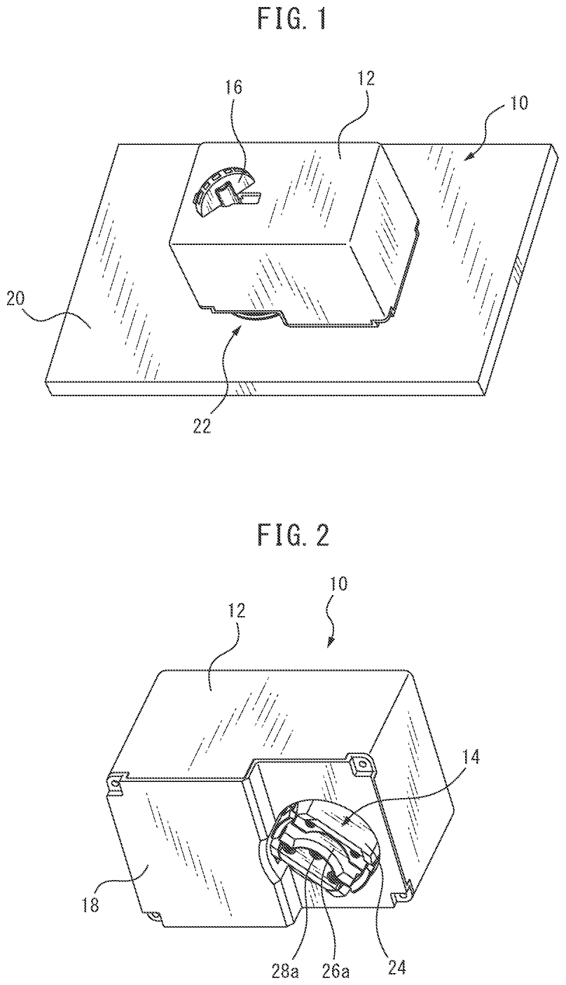

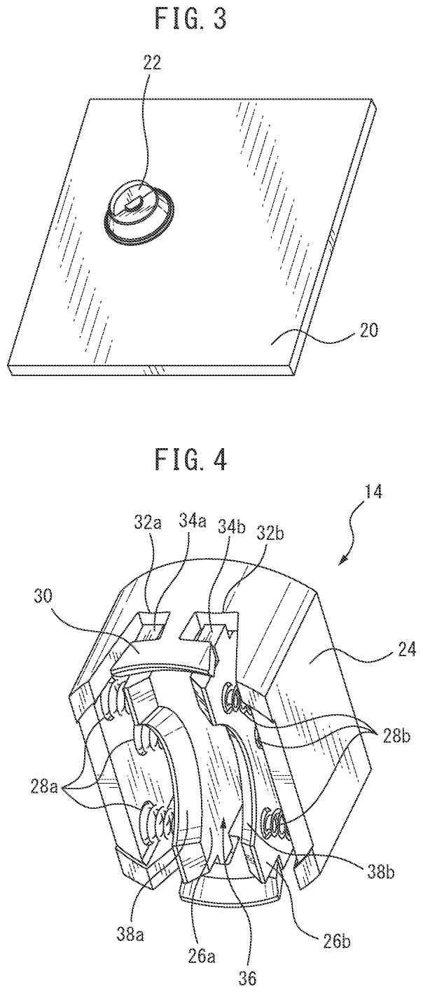

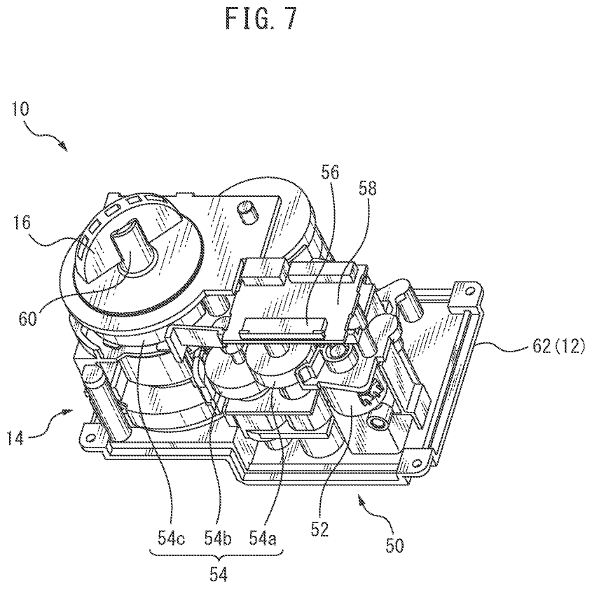

FIG. 1 is a perspective view of a smart lock 10 according to a preferred embodiment, and FIG. 2 is a perspective view of the smart lock 10 viewed from a different angle than FIG. 1. The smart lock 10 includes a housing 12, a knob holding structure 14 arranged in the housing 12, and a drive mechanism 50 (see FIG. 7) arranged in the housing 12 and configured to rotationally drive the knob holding structure 14 relative to the housing 12. The smart lock 10 is configured, for example, to rotate a thumb-turn type knob 22 arranged on a door 20, partially shown in FIG. 3, by remote control. For example, while the knob holding structure 14 holds the knob 22, the drive mechanism 50 can rotationally drive the knob holding structure 14 by remote control from an electronic device (not shown) such as a smart phone, thereby rotating the knob 22. The knob 22 is not limited to a thumb-turn, and may include a lever, a latch, etc., which locks and unlocks the door by being rotated or moved.

The smart lock 10 can be attached to door 20 by various means. For example, an attachment surface 18 of the smart lock 10 as shown in FIG. 2 can be adhered to the door 20 in place by using a double-sided adhesive tape or adhesive agent, etc. (not shown). As also shown in FIG. 1, the smart lock 10 may have an operation knob 16 connected to the knob holding structure 14 so that the knob 22 may also be manually rotated. The operation knob 16 is connected to, for example, a rotary shaft part 44 as shown in FIG. 6.

FIG. 4 is a view of a configuration example of the knob holding structure 14 as viewed from the side attached to the door 20 (hereinafter, also referred to as the bottom side). The knob holding structure 14 includes a holder 24, a pair of pinching members 26a and 26b configured to hold the knob 22 and arranged opposed to each other in the holder 24, and elastic members 28a and 28b. The clastic members 28a and 28b are configured to support the pair of pinching members 26a and 26b so that each pinching member can be displaced relative to an inner surface of the holder 24, and to bias the pinching members 26a and 26b in a direction to approach each other, respectively. In the illustrated example, the pinching members 26a and 26b are plate-like members (hereinafter also referred to as pinching plates), and the elastic members 28a and 28b are a plurality of coil springs. There is no particular restriction on the number of coil springs.

The pair of pinching plates 26a and 26b are arranged apart from each other by a predetermined distance on the bottom side. In the illustrated example, the pair of pinching plates 26a and 26b are biased toward each other by the coil springs 28a and 28b, respectively, and are retained so as to be separated by a constant distance by a support part 30 constructed as a part of the holder 24.

More specifically, the support part 30 is formed as a substantially T-shaped part by forming slits 32a and 32b in a portion of the holder 24 in the direction in which the pair of pinching plates 26a and 26b can move toward and away from each other. On the other hand, the pinching plates 26a and 26b have protrusions 34a and 34b capable of moving in the slits 32a and 32b, respectively. Due to such a configuration, the pinching plates 26a and 26b can be elastically displaced in the direction of contacting and separating from each other within a range corresponding to the lengths of the slits 32a and 32b in the directions of the displacements of the pinching plates 26a and 26b, respectively. In addition, since the slits 32a and 32b allow the moving direction of the pinching plates 26a and 26b to be substantially limited to the contact and separation direction, the motions of the pinching plates 26a and 26b can be stabilized and the knob 22 can be held appropriately. However, this is merely an example. Therefore, even when support part 30 is not provided, the pair of pinching plates 26a and 26b can be separated from each other by a proper distance by appropriately selecting the number, size, spring constant, etc., of each of the coil springs 28a and 28b.

When attaching the smart lock 10 to the door 20 as shown in FIG. 1, an operator manipulates the housing 12 so that the knob 22 is inserted into a gap 36 between the pair of pinching plates 26a and 26b. Although it is desirable that the gap 36 have a width somewhat less than the thickness of the knob 22 before attachment, the pinching plates 26a and 26b are supported by the coil springs 28a and 28b, respectively, as described above. Thus, when the housing 12 is pressed against the knob 22, at least one of the pinching plates 26a and 26b is elastically displaced in the direction of contacting and separating from each other. Therefore, even when the operator does not precisely position the housing 12 with respect to the knob 22, the knob 22 can be smoothly inserted into the gap 36.

In order to facilitate the insertion of the knob 22, as shown in FIG. 4, it is preferable that the pinching plates 26a and 26b have tapered surfaces 38a and 38b at a portion (end surface) facing the bottom side (i.e., at a side into which the knob 22 is inserted), respectively. Depending on the shapes of the tapered surfaces 38a and 38b, the pair of pinching plates 26a and 26b may be in contact with each other before being attached. However, it is preferable that the pinching plates 26a and 26b are separated from each other by the predetermined distance due to the above support part 30, from the viewpoint of case of insertion of the knob 22. In addition, the tapered surface may be provided only on one of the pinching plates.

When the knob 22 is inserted into the gap 36, the distance between the pinching plates 26a and 26b is increased against the spring pressure of the coil springs 28a and 28b, and the knob 22 is pinched between the pinching plates 26a and 26b. At this time, the position of the holder 24 relative to the knob 22 is automatically adjusted so that the center of rotation of the knob 22 and the center of rotation of the holder 24 are aligned by the balance of the spring pressure of the coil springs 28a and 28b. Therefore, the operator can attach the smart lock 10 to the door 20 with sufficient accuracy for practical use by a simple operation which does not require time-consuming positioning or adjustment.

In the state in which the knob 22 is held by the holder 24, more specifically in the state in which the knob 22 is pinched between the pinching plates 26a and 26b, the knob 22 can be rotated together with the holder 24 by the drive mechanism 50 as described later. Further, when the rotation angle of the holder 24 becomes larger than the maximum rotation angle based on the specifications, etc., of the knob 22, at least one of the coil springs 28a and 28b can be elastically displaced so as to absorb excessive rotational movement of the holder 24, thereby preventing excessive force from being applied to the knob 22.

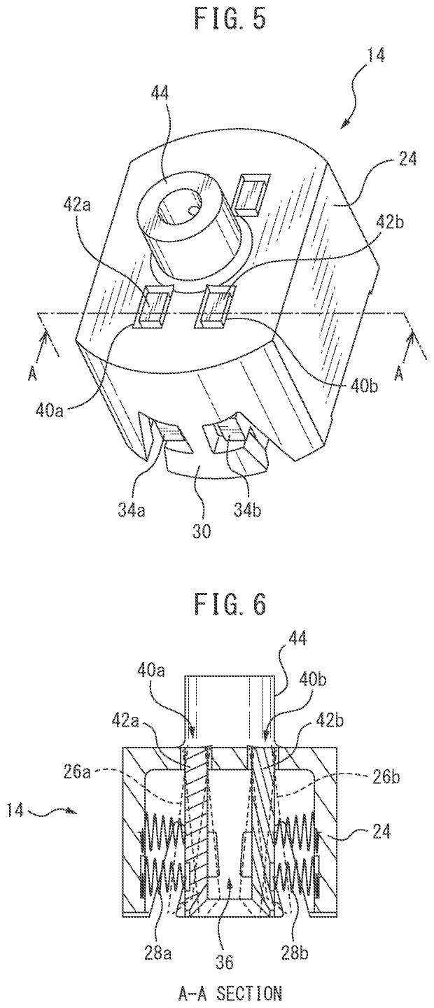

FIG. 5 is a view of the knob holding structure 14 viewed from the top side opposite to the bottom side, and FIG. 6 is a cross-sectional view taken along a line A-A in FIG. 5. The holder 24 is configured to support the pinching plates 26a and 26b so as to be capable of swinging in direction toward and away from each other. In the illustrated example, holes or recesses 40a and 40b are formed in an upper surface of the holder 24, and protrusions 42a and 42b formed on upper surfaces of the pinching plates 26a and 26b are engaged with holes 40a and 40b, respectively. Due to such a configuration, as shown in FIG. 6, the pinching plates 26a and 26b are capable of swinging about the holes 40a and 40b, respectively, and thus the knob 22 can be stably pinched and held while being attached.

Although there are no particular restrictions on the material of each member constituting the knob holding structure 14, the holder 24 and the pinching plates 26a and 26b are preferably made of resin from the viewpoint of case of manufacture and weight. On the other hand, the coil springs 28a and 28b are preferably made of metal. Elastic bodies other than the coil springs can also be used, such as leaf springs, rubber, and sponges, etc.

FIG. 7 shows a configuration example of a drive mechanism 50 for rotationally driving the knob holding structure 14. The drive mechanism 50 has a drive motor 52 and a gear unit 54 configured to transmit the rotational torque of the drive motor 52 to the holder 24, and the entirety of the drive mechanism 50 can be accommodated within the housing 12. However, in FIG. 7, only a bottom part 62 having the attachment surface 18 (FIG. 2) of the housing 12 is shown for the purpose of explanation.

Within the housing 12, a control board 58 on which a processor 56, etc., is mounted can also be accommodated. The processor 56 is configured to control the drive motor 52 based on remote control from the electronic device such as a smart phone.

The gear unit 54 has at least one gear, and in the illustrated example, has three gears 54a, 54b and 54c engaged in series. When the gear 54c is engaged with the rotary shaft part 44 (sec FIG. 5) of the holder 24, the knob 22 held by the holder 24 is rotated by the rotation of the motor 52. However, this is merely an example, and the number of the gears and the number of teeth of each gear constituting the gear unit 54 can be appropriately selected, based on the specifications of the drive motor 52 and/or the desired rotational speed of the knob 22, etc.

It is preferable that the knob holding structure 14 be also manually rotatable. For example, by connecting a rotary shaft part 60 of the operation knob 16 to the rotary shaft part 44 (see FIG. 5) of the holder 24, the knob 22 held by the holder 24 can be rotated manually rotated when the operator rotates the operation knob 16.

All examples and conditional language provided herein are intended for the purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations can be made hereto without departing from the spirit and scope of the invention.

What is claimed is:

1. A knob holding structure comprising:
a holder;
a pair of pinching members configured to hold a knob and arranged opposed to each other in the holder; and
an elastic member configured to support the pair of pinching members so that each pinching member can be displaced relative to an inner surface of the holder, and to bias the pinching members in a direction so as to approach each other.

2. The knob holding structure according to claim 1, wherein the holder has a slit configured to support the pair of pinching members and extending in a direction in which the pair of pinching members contact and separate from each other.

3. The knob holding structure according to claim 1, wherein the pair of pinching members are configured to be swingable about a part of the holder as a fulcrum.

4. The knob holding structure according to claim 1, wherein a least one of the pair of pinching members has a tapered surface at a side into which the knob is inserted.

5. A smart lock comprising:
a knob holding structure comprising:
a holder;
a pair of pinching members configured to hold a knob and arranged opposed to each other in the holder; and
an elastic member configured to support the pair of pinching members so that each pinching member can be displaced relative to an inner surface of the holder, and to bias the pinching members in a direction so as to approach each other; and
a drive mechanism configured to rotationally drive the holder.
